(19) United States
(12) Patent Application Publication
(10) Pub. No.: US 2017/0119014 A1
(43) Pub. Date: May 4, 2017

(54) LIQUID NITROGEN INJECTION NOZZLE

(71) Applicants: Michael D. Newman, Hillsborough, NJ (US); Thomas Edward Kilburn, Pennsburg, PA (US)

(72) Inventors: Michael D. Newman, Hillsborough, NJ (US); Thomas Edward Kilburn, Pennsburg, PA (US)

(21) Appl. No.: 15/298,465

(22) Filed: Oct. 20, 2016

Related U.S. Application Data
(60) Provisional application No. 62/250,531, filed on Nov. 4, 2015.

(51) Int. Cl. A23G 9/22; A23L 3/36

(52) U.S. Cl. CPC A23G 9/228; A23L 3/36; A23V 2002/00

(57) ABSTRACT

A cryogen injection apparatus for injecting a cryogenic substance to a blender includes at least one nozzle constructed for being in fluid communication with an interior of the blender; a heat transfer fluid for being operationally associated by conduction with the at least one nozzle; and a heat transfer housing supporting the at least one nozzle and having a space therein for receipt of the heat transfer fluid to warm the at least one nozzle. A related method is also provided.

### BACKGROUND OF THE INVENTION

The present embodiments related to nozzle apparatus that introduce cryogen substances into food products for chilling and/or freezing same, and which apparatus are not clogged from use of the cryogenic substance.

The bottom injection of cryogen into mixers for cooling food products, for example, are known. Such known bottom injection nozzles for cryogenic substances, such as for example liquid nitrogen (LIN), encounter difficulties when being used with wet products which are drawn into an orifice of the nozzle in communication with the food processing equipment, whereupon the wet food product is frozen upon exposure to the cryogen. When such a situation occurs, the nozzle orifice will become restricted and eventually clogged. Unfortunately, it is extremely difficult to clear the nozzle and no further cooling cryogenic substance can be delivered to the mixer for chilling until the clog is removed.

Existing nozzle structure contributes to this deficiency. That is, known nozzles are made from either thick stainless steel, which transfers a large amount of heat from the mixture or blender wall and thereafter remains cold after an injection cycle of the cryogen until the mixing is complete. This type of stainless steel nozzle contributes to the clogging situation when the cryogenic substance, such as LIN for example, is exposed to the wet product in the blender or mixer.

Other nozzles are manufactured with a teflon sleeve which reduces the amount of heat transfer from the blender wall to the nozzle, but such nozzles are susceptible to migration of the food product between the sleeve and the housing and will therefore crack the nozzle due to thermal expansion and contraction from the cryogenic substance.

### SUMMARY OF THE INVENTION

There is therefore provided a low thermal mass straight bore (or expanding bore) nozzle with an integrated heating system which will provide for quick warming or thawing of the nozzle, therefore clearing of any product within the nozzle between injection cycles of cryogen from the nozzle. The present nozzle embodiments also eliminate cracking of the nozzle because an internal sleeve for the nozzle has been eliminated in the present embodiments.

There is provided a cryogen injection apparatus for injecting a cryogenic substance into a blender, which includes at least one nozzle constructed for being in fluid communication with an interior of the blender; a heat transfer fluid for being operationally associated by conduction with the at least one nozzle; and a heat transfer housing supporting the at least one nozzle and having a space therein for receipt of the heat transfer fluid to warm the at least one nozzle.

There is also provided a method for heat transfer of an injection nozzle providing a cryogenic substance to a blender, which includes supporting the injection nozzle at a wall of the blender for being in communication with an interior of said blender; and providing heat transfer with a fluid to said injection nozzle.

### BRIEF DESCRIPTION OF THE DRAWINGS

For a more complete understanding of the present invention, reference may be had to the following description of exemplary embodiments considered in connection with the accompanying drawing Figures, of which:

FIGS. 1-2 show side and perspective views, respectively, of the cryogen injection nozzle embodiment of the present invention;

FIG. 3. shows a perspective, exploded view of the embodiment of FIGS. 1 and 2;

FIGS. 4A-4B show top and side cross-section views, respectively, of certain elements of the embodiment of FIG. 3;

FIG. 5. shows a perspective, partial-transparent view of another embodiment of the injection nozzle; and

FIG. 6. shows a side view partially in cross-section of the nozzle embodiment of FIG. 5.

### DETAILED DESCRIPTION OF THE INVENTION

Before explaining the inventive embodiments in detail, it is to be understood that the invention is not limited in its application to the details of construction and arrangement of parts illustrated in the accompanying drawings, since the invention is capable of other embodiments and being practiced or carried out in various ways. Also, it is to be understood that the phraseology or terminology employed herein is for the purpose of description and not of limitation.

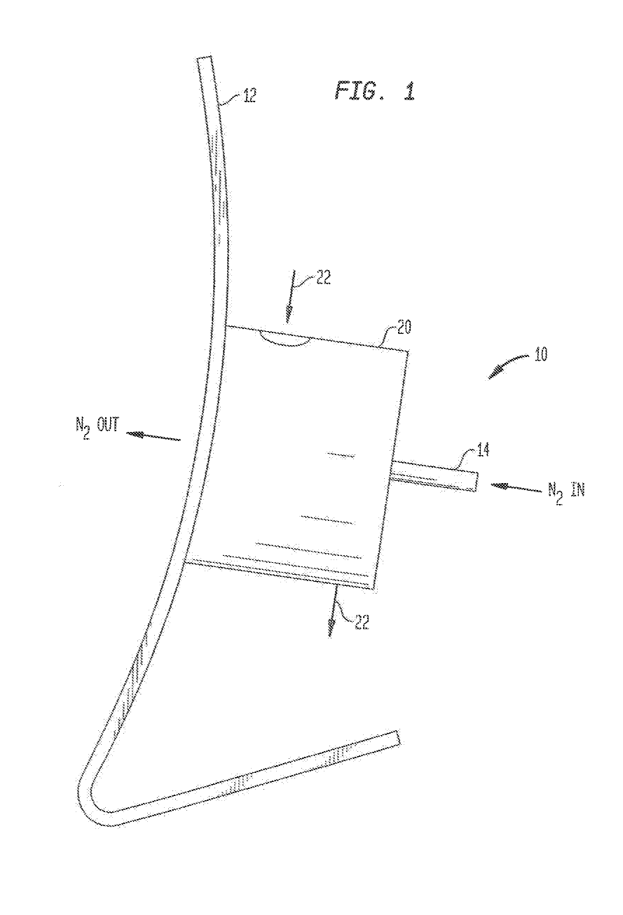

Referring to FIGS. 1-3, an injection nozzle apparatus of a first embodiment of the present invention is shown generally at 10 mounted to a wall 12 of a blender or mixer (not shown) in which food product (not shown) is disposed for being chilled. While food product is referred to for being treated by the injection nozzle 10, it is understood that other types of product can be treated with the present injection nozzle embodiment.

The injection nozzle 10 consists of a nozzle or nozzle portion 14, a heat sink member 16, a flow block member 18 and an outer cover 20 or housing. A mechanical fastener such as for example a nut 21 removably mounts the heat sink member 16 to the nozzle portion 14 as discussed below. The nozzle portion 14 delivers liquid nitrogen, such as LIN, into the blender. The nozzle 14 can be either a straight bore stainless steel tube or a machined steel tube with an expanding bore, wherein a diameter of the bore increases along the flow path in the direction of the wall 12. The nozzle 14 is constructed from a material that has a low thermal mass.

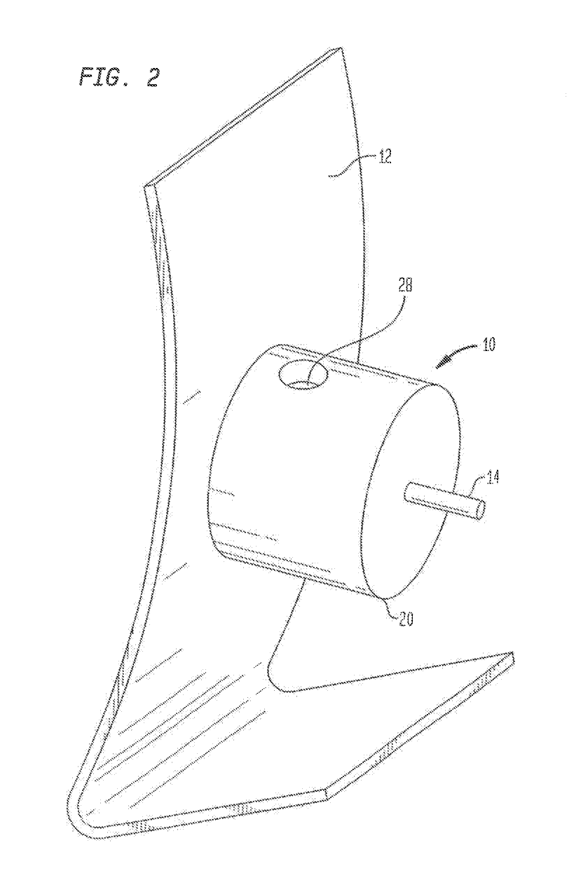

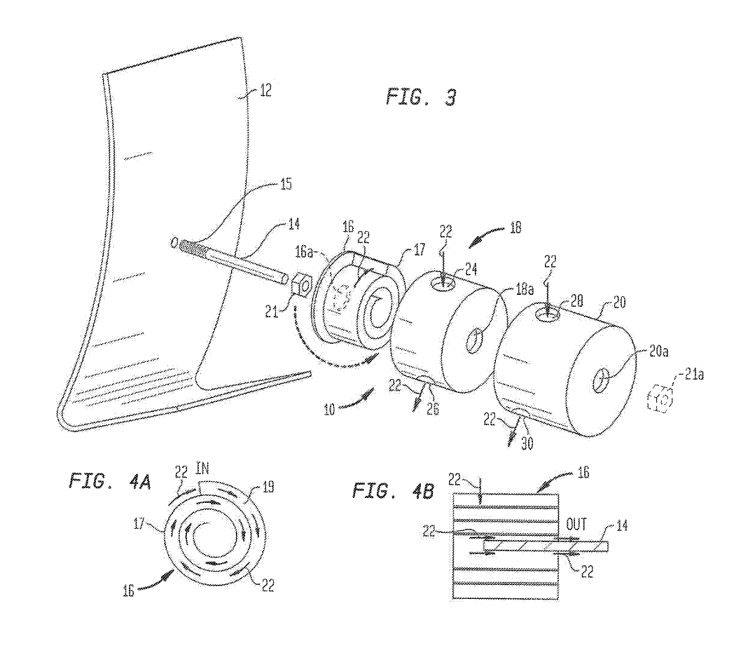

Referring also to FIGS. 4A and 4B, the heat sink member 16 is used to transfer heat to the blender wall 12 and the nozzle 14. The heat sink member 16 is constructed with a spiral fin 17 for providing a continuous spiral path 19 of the heat sink member 16 as shown for example in FIGS. 3 and 4A, so that any applied heat transfer fluid 22 must travel through the spiral path 19. A higher velocity of the heat transfer fluid 22 through the spiral path 19 will provide for an increase in heat transfer between the wall 12 and the heat sink member 16. The heat transfer fluid 22 is discharged from the heat sink member 16 along an axial orientation of the nozzle 14 and then out of the housing 20. Heat is first transferred into the wall 12 and then to the nozzle 14. A thermal mass of the wall 12 is greater than a thermal mass of the nozzle 14. Therefore, any of the heat transfer fluid 22 with a sufficient temperature and thermal conductivity can be used, such as for example water, steam, air, hot gas, etc.

Referring in particular to FIGS. 2-3, the flow block member 18 includes an inlet port 24 and an outlet port 26. The housing 20 also includes a inlet port 28 and outlet port 30. When the injection nozzle 10 of for example FIG. 3 is assembled into what is represented at FIG. 2, the inlet ports 24, 28 can be, although do not have to be, in registration with each other, while the outlet ports 26, 30 can be, although do not have to be, in registration with each other to provide for the flow of the heat transfer fluid 22 into the spiral path 19 for providing heat transfer and to ultimately be exhausted from the outlet port 30. The flow block member 18 is used to contain and direct the flow of the heat transfer fluid 22 to the heat sink member 16 and through the spiral path 19.

The housing 20 retains the heat sink member 16 and the flow block member 18 as being releasably mounted together and protects the injection nozzle 10 from external pressure water sprays and cleaning agents.

The nozzle portion 14 may be constructed from stainless steel; the heat sink member 16 may be constructed from brass, copper or any other material having high thermal conductivity; the flow block member 18 may be constructed from stainless steel or plastic; and the outer cover or housing 20 may be constructed from stainless steel.

The injection nozzle 10 of the embodiment showing in FIGS. 1-4B permits the nozzle to be easily cleaned, because the only elements of the nozzle exposed to an interior of the blender is an interior of the nozzle portion 14. Therefore, hot water or other cleaning solutions can be sprayed through the nozzle portion 14 for easy cleaning without having to disassemble the injection nozzle 10.

Referring to FIGS. 1, 3 and 4A-4B, the flow of the heat transfer fluid 22 is as follows. The heat transfer fluid 22 is introduced into the inlet port 28 of the outer cover 20 and flows through the inlet port 24 of the flow block 18. The inlet ports 24, 28 may be in registration with each other in order to facilitate the flow of the heat transfer fluid 22. The heat transfer fluid 22 is thereafter introduced into the spiral path 19 of the heat sink member 16 which is seated within the flow block 18, for the fluid to move along the spiral path 19 where heat transfer occurs for the nozzle 14 and the wall 12 of the blender. Upon completion of the heat transfer fluid 22 travelling along the spiral path 19, the fluid is directed back into the flow block 18 whereupon the fluid exits the block from the outlet port 26 as shown in FIG. 3. The outlet port of the flow block member 18 may be in registration with the outlet port 30 of the outer cover 20, when the flow block member 18 is seated within the outer cover 20 such that the fluid 22 can be exhausted quickly from the heat sink member 16 and the flow block 18.

The heat sink member 16, the flow block member 18 and the outer cover 20 each have a corresponding central axial hole 16a, 18a, 20a, respectively, as shown for example in FIG. 3 which, when such elements are mounted to the nozzle 14, are in registration with each other so that the injection nozzle apparatus 10 can be mounted to the wall 12 as shown in FIGS. 1-2. The nozzle portion 14 extends through the wall 12 of the blender and has an exterior threaded surface area 15, as shown. The nozzle portion 14 is disposed through the central axial hole 16a of the heat sink member 16 and the mechanical fastener, such as the nut 21, is threaded to the threaded area 15 of the nozzle 14. The flow block member 18 is seated by friction fit or crimping to the heat sink member 16, and the outer cover 20 may be similarly mounted to the flow block 18. An alternate embodiment can have a mechanical fastener 21a (a nut) positioned as shown to threadably engage the nozzle portion 14 where it protrudes through the central axial hole 20a of the outer cover 20. In such an embodiment, the nozzle portion 14 has a threaded surface area at that portion protruding from the outer cover. With this embodiment, the apparatus 10 can be fabricated as a single, integral unit to be mounted to the wall 12 of the blender.

In operation with the blender (not shown), a batch of food product, such as for example ground meat with ingredients therein, is placed in the blender which is started such that internal blades (not shown) of the blender mix the food product and ingredients. It is required to chill the meat during the blending operation and therefore, cryogen such as liquid nitrogen (LIN) is injected into the blender through the injection nozzle 10. That is, the LIN is injected through the nozzle portion 14 during which heat is transferred from the wall 12 via conduction with the nozzle portion 14 which also has its temperature reduced to a temperature substantially similar to that of the LIN. Minimal heat is transferred between the wall 12 and the nozzle portion 14 due to a low thermal mass of the nozzle portion. When a desired, reduced temperature of the meat is obtained, the LIN injection is stopped and the meat is removed from the blender. The heat transfer fluid 22 is introduced into the inlet port 28 of the outer cover 20 as explained above to rapidly thaw the injection nozzle 14. Any meat or water trapped within the nozzle portion 14 is warmed and can be easily discharged at a start of the next batch of food product being used in the blender. That is, because the nozzle 14 has been warmed and therefore, thawed by the heat transfer fluid 22 circulating through the spiral path 19 of the heat sink member 16, the next injection of LIN through the nozzle portion 14 will forceably expel any trapped food product or water, or clog of such, into the blender. The next batch of meat is thereby loaded into the blender and the process continues. The construction of the injection nozzle apparatus 10 permits clean-in-place (CIP) of the nozzle portion 14 without removal or disassembly of the apparatus.

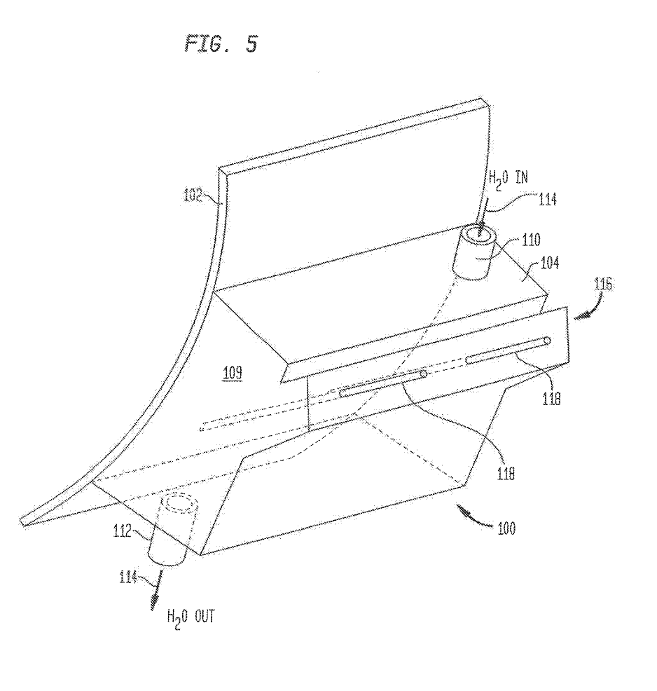

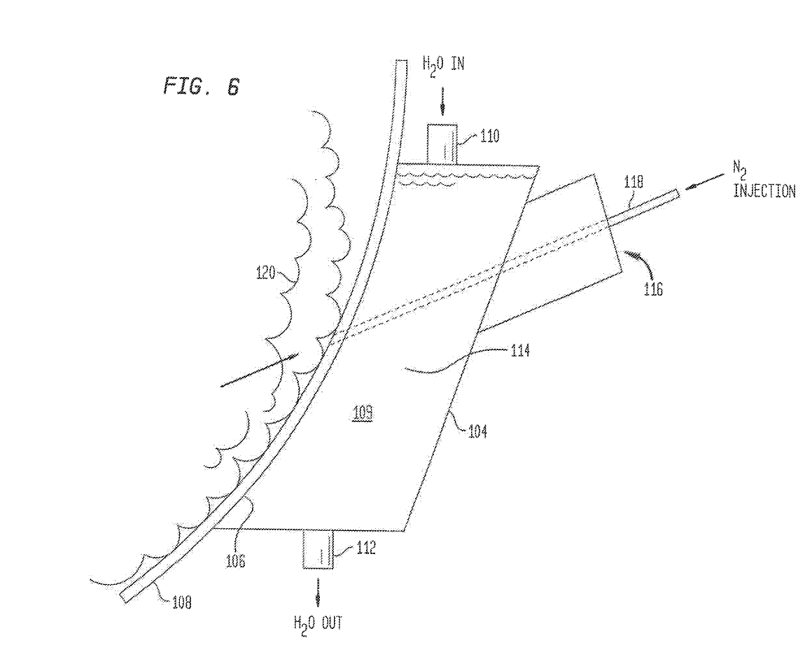

Referring to FIGS. 5-6, another embodiment of the injection nozzle apparatus is shown generally at 100 mounted to a wall 102 of a blender or mixer (not shown). In this embodiment, water is used to defrost or thaw the apparatus 100 and the wall 102 after an injection cycle of LIN is introduced to the blender.

The injection nozzle apparatus 100 includes a housing 104 or enclosure which can be manufactured from stainless steel. The housing 104 includes a plurality of sidewalls, one of such sidewall 106 having a surface area substantially conforming to a shape of an exterior surface of the wall 102. The sidewall 106 permits the housing 104 to lie flush against an exterior surface 108 of the wall 102. The sidewalls of the housing 104 define a space 109 or chamber therein. An inlet port 110 is provided at an upper sidewall of the housing 104, while an outlet port 112 is provided at a lower one of the sidewalls of the housing. A heat transfer fluid 114, such as for example water, is introduced into the inlet port 112 and therefore into the space 109 after which the fluid can be removed from the space through the outlet port 112.

The sidewalls of the housing 104 may be arranged to provide an extended portion 116 through which at least one cryogen injection nozzle 118 extends and through the space 109 and the wall 102 for opening into the blender where food product 120 is being chilled. The extended portion 116 provides a larger volume of the space 109 only where the injection nozzle(s) 118 are disposed so that heat transfer is more thorough, uniform, and occurs more quickly. It is not necessary to have the remainder of the space 109 to be sized similar to that of the extended portion 116. The cryogen may be liquid nitrogen (LIN). In the embodiment shown in FIGS. 5-6, there are a pair of the injection nozzles 118, but it is understood that one or a plurality of the nozzles can be used depending upon the amount of LIN to be introduced into the blender and the nature or type of the product 120 being processed therein.

During operation, the heat transfer fluid 114, such as water for example, is purged from the space 109 of the housing 104, and a cryogen injection cycle begins having a duration of approximately 6 to 8 minutes, during which occurs LIN injected through the nozzles 118 to the food product 120 in the blender. When the injection cycle stops, the heat transfer fluid 114, in this case water, is introduced into the space 109 from the inlet port 110 at a rate of approximately 10-30 L/hr. for a period of from six to twelve minutes. The water will defrost or thaw the injection nozzle(s) 118 and the surface 108 and wall 102 in close proximity to the sidewall 106. Accordingly, there should be no frozen food product or condensate in the injection nozzle 118. Any frozen product or moisture in the injection nozzle(s) 118 has been warmed to a temperature sufficient to eject same into the blender at the next LIN injection cycle. The water 114 is then purged from the space 108 of the housing 104 and a subsequent cryogen cycle begins. The tubing of the injection nozzle 118 or nozzles permits clean-in-place (CIP) of the nozzle without removal of same from the housing 104. Valving (not shown) operatively associated with the outlet port 112 can be used to retain the heat transfer fluid 114 to a specific depth or amount in the space 109 to carry out the heat transfer effect of the nozzles (118).

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed is:

1. A cryogen injection apparatus for injecting a cryogenic substance into a blender, comprising:
at least one nozzle constructed for being in fluid communication with an interior of the blender;
a heat transfer fluid for being operationally associated by conduction with the at least one nozzle; and
a heat transfer housing supporting the at least one nozzle and having a space therein for receipt of the heat transfer fluid to warm the at least one nozzle.

2. The apparatus of claim 1, wherein the heat transfer housing comprises an enclosure having a fin at the space for providing a flow path for the heat transfer fluid in the space.

3. The apparatus of claim 2, wherein the flow path is continuous.

4. The apparatus of claim 1, wherein the heat transfer housing comprises an enclosure having a chamber therein through which the at least one nozzle is disposed and in which the heat transfer fluid is releasably retained to warm the at least one nozzle.

5. The apparatus of claim 1, wherein the heat transfer fluid is a fluid selected from the group consisting of water, steam, air, and hot gas.

6. The apparatus of claim 2, further comprising a block housing having a first open end sized and shaped to receive the heat transfer housing therein to restrict the heat transfer fluid to said flow path.

7. The apparatus of claim 6, further comprising an outer housing having a second open end sized and shaped to receive the block housing therein to protect said block housing and said heat transfer housing.

8. The apparatus of claim 4, wherein the heat transfer housing comprises an exterior surface having a shape conforming to an external portion of the blender for being mounted flush thereto.

9. The apparatus of claim 4, further comprising an inlet port in fluid communication with the chamber, and an outlet port in fluid communication with the chamber.

10. A method for heat transfer of an injection nozzle providing a cryogenic substance to a blender, comprising:
supporting the injection nozzle at a wall of the blender for being in communication with an interior of said blender; and
providing heat transfer with a fluid to said injection nozzle.

11. The method of claim 10, wherein the warming further comprises defrosting any frozen matter within the injection nozzle.

12. The method of claim 10, further comprising exhausting the fluid away from the injection nozzle.

13. The method of claim 12, further comprising expelling any material from the injection nozzle for clearing said injection nozzle.

14. The method of claim 10, further comprising retaining the fluid in contact with the injection nozzle for a select amount of time.

15. The method of claim 10, wherein the fluid is a substance selected from the group consisting of water, steam, air, hot gas, and combinations thereof.
